(19) United States
(12) Patent Application Publication
(10) Pub. No.: US 2010/0064139 A1
(43) Pub. Date: Mar. 11, 2010

(54) SYSTEM AND METHOD OF EXTENDING MARKING INFORMATION IN CONTENT DISTRIBUTION

(75) Inventor: Jeffrey Courington, Chester, VA (US)

Correspondence Address: Dolby Laboratories Inc., 100 Potrero Avenue, San Francisco, CA, 94103-4938, US

(73) Assignee: Dolby Laboratories Licensing Corporation, San Francisco, CA (US)

(21) Appl. No.: 12/555,385

(22) Filed: Sep. 8, 2009

Related U.S. Application Data
(60) Provisional application No. 61/095,857, filed on Sep. 10, 2008.

(51) Int. Cl. H04L 9/32

(52) U.S. Cl. 713/176

(57) ABSTRACT

In one embodiment the present invention includes a method of generating tracking information for steganographic insertion in content. The method includes splitting a tracking message into submessages, which are then inserted steganographically into the content and later extracted for tracking purposes. In this manner, the amount of information communicated in the tracking messages may be increased without requiring a redesign of every message insertion device in a distribution chain.

### CROSS REFERENCE TO RELATED APPLICATIONS

This application claims priority to U.S. Provisional Patent Application No. 61/095,857, filed 10 Sep. 2008, hereby incorporated by reference in its entirety.

### BACKGROUND

The present invention relates to tracking the distribution of digital information, and in particular, to the marking information that is used for tracking.

Unless otherwise indicated herein, the approaches described in this section are not prior art to the claims in this application and are not admitted to be prior art by inclusion in this section.

In the following description, the term “content” is used. In general, content refers to digital information such as picture data, video data, and audio data. In general, content may be distributed via physical copies (such as compact disks, video disks and hard disks) and via transmission (such as radio signals, satellite signals, and computer network data). In general, content is subject to copyright (e.g., an original work of authorship fixed in a tangible form of expression).

Movie producers and broadcasters want to bring higher value content direct to consumers in order to increase direct revenues. System operators—satellite, cable, and telecommunications companies—are investing in high bandwidth networks to carry this content. But, advances in digital technology play to the hands of the pirates as well. Today, exact copies of digital content can be made faster than the time it takes to play the content. Improvements in computer and broadband technology will only continue to reduce the time it takes to copy and transfer full length movies. Pirated video content is traded anonymously and the content itself does not reveal anything about the parties involved in the trading. Otherwise “honest” people may be encouraged to download movies from the internet because they believe they will remain anonymous and will not be held responsible for their actions.

Digital forensic watermarking, when coupled with digital rights management (DRM) systems, can reduce the trading of content by allowing content owners and system providers the ability to trace the un-authorized distribution of content back to its source.

DRM and Conditional Access (CA) systems are used to control access to content. In recent years this functionality has matured from just scrambling the channel to actual encryption and management of complex sets of permissions that define how the content may be used by the consumer. As DRM and CA functionality merges, the term DRM is becoming the superset of content protection, which includes CA, content protection and content rights. Within the newer markets of IPTV and mobile content, DRM and CA are increasingly integrated into a single offering. This trend will follow over time in legacy markets such as satellite and cable. High value content such as delivered as video-on-demand (VOD), high profile live events, and high definition content will need comprehensive protection in new and legacy markets.

Digital watermarks are data embedded into digital audio and video that are readable by computers and other processing devices. Watermarks may be used for various purposes. One type, forensic watermarks, are used to trace the distribution path of legitimate content—so when that content is pirated, the source can be identified—such as the specific set-top box that played the content before it was copied. Fundamentally, these marks are generally invisible and/or inaudible (imperceptibility), they resist intentional and unintentional attempts to delete them (robustness), and they may be recovered with sufficient assurance that they can be relied upon to pinpoint the source of the leak. In general, the term “steganography” refers to the process of hiding messages in content such that observers of the content do not perceive the hidden message.

Content owners and system operators desire is to give tens of millions of legitimate customers access to a broad range of content on the playback device, at the time and place of their choosing, while at the same time, not allowing that content to be redistributed illegally.

But, content owners must maintain a delicate balance between content control and customer usage. Strong content control may reduce piracy but also decrease legitimate sales and total revenue. Conversely, weak content control may increase legitimate sales but also result in increased piracy, again reducing total revenue.

Today's conditional access and digital rights management systems do a good job of protecting the content for the first sale or first usage. But once the content is in the hands of the consumer, the ability to redistribute the content, in a high quality digital format, is readily available. Today's consumers can easily bypass the home video DVD CSS encryption. Satellite and VOD systems are more successful in preventing content leakage during distribution to the home and ensuring that only paying customers access the content, by encrypting the content during distribution and decrypting in the home just prior to display. But even these systems are prone to theft. Once the content is decrypted, it is again vulnerable to unauthorized redistribution. There are known cases of legitimate DBS customers capturing and re-broadcasting an entire slate of programming without authority. Another source of content leakage is the installed base of televisions using an analog connection between the source and the display. Today's consumer computer technology easily allows this analog signal to be captured, digitally encoded and posted on the Internet for anyone in the world to access. While analog connections to displays are being eliminated, the new digital connections, such as HDMI, will certainly be circumvented for the purposes of redistributing content. It only takes one non-compliant or hacked device, for unauthorized re-distribution to take place.

Forensic watermarking is an anti-piracy tool that is a complement to the Conditional Access and Digital Rights Management systems. As described above, forensics watermarking is the embedding of a message within the video that identifies the last authorized party. A forensic watermark can be placed in content at various points along its distribution. If content is found outside of an authorized distribution path, the forensic watermark contained in the content can be used to identify the source of the leak. Today, content distributors and system operators often insert a watermark that identifies the system operator. That is of limited use in identifying pirates. System operators are much more interested in placing a forensic watermark at their head-ends, at interim points along the distribution path, and in the consumer playback device itself. This systematic use of forensic watermarks fully identifies the path to an authorized consumer and eliminates the opportunity for anonymous redistribution. It also provides a way to monitor the overall integrity of the CA/DRM so that the system operator is more easily aware of when they have a leak and can take early action to renew their security system to stop that leak.

In general, forensic watermarking systems perform the following steps. First, determine where to place the mark. Second, determine what changes are acceptable at a location. Third, insert the mark. The first two steps comprise an analysis phase while the third step conveys the desired message.

Forensic watermarking systems may be further categorized into two general categories: Single ended systems and replacement based systems.

Single ended systems treat these three steps as one monolithic operation. This architecture, designed with the professional market in mind, makes them particularly unsuited for the consumer marketplace. First, in order to insert a message that is imperceptible and robust the analysis component is computationally intensive. This adds significant cost to the inserter, forcing a trade-off between cost and quality. Second, it may be problematic to renew the processes used in the analysis engine if the watermarking method is compromised. Upgrading each fielded device is both logistically difficult and costly. And third, a single-ended watermark must typically be inserted in the base band, outside the purview of the DRM security envelope, making the watermark vulnerable to attack.

In summary, the characteristics of a single ended system requires significant computational and memory resources for every insertion. These system requirements make it an impractical design for the consumer marketplace.

In a replacement based watermarking architecture the analysis component is separated from the conveying of the message (“inserter”). The analysis occurs once in a pre-processing step creating a set of metadata that is then conveyed with the content to an inserter. Each inserter that follows then uses this metadata combined with the desired message to make the required changes in the compressed content.

This architecture provides the following advantages:

First, the inserter requires minimal computational and memory resources since all the analysis is performed in the Pre-Processor. This allows the same inserter to be used across the range of playback devices supported by the system operator, from STBs to handheld video devices.

Second, the Pre-Processor processes can be changed without affecting the inserter. This means the operator can renew the watermarking method without having to upgrade any inserters in the field.

Third, the Pre-Processor is performed once at ingest, enabling multiple insertions, if desired, at very high speeds as the content flows through the distribution and playback chain.

Fourth, the system works in the compressed domain thus allowing the technology to reside inside the secure envelope of the DRM/CA providers.

An example of a replacement based watermarking system may be seen in U.S. Pat. No. 6,285,774.

### SUMMARY

Embodiments of the present invention improve the tracking messages that are used in forensic watermarking. In one embodiment the present invention includes splitting a tracking message into submessages, which are then inserted steganographically into the content and later extracted and recombined for tracking purposes.

In one embodiment, a computer-implemented method generates tracking information to track content steganographically. The method includes receiving processed content at a device. The processed content has been previously processed for subsequent steganographic insertion of a plurality of tracking messages. The method further includes generating a tracking message that identifies the device. The method further includes generating submessages from the tracking message. The submessages include the tracking message and include relationship information that relates the submessages together. The method further includes inserting the submessages steganographically into the processed content. The method further includes outputting the processed content that includes the submessages.

Various processes may be used to generate the relationship information, including a cyclic redundancy check, a cryptographic hash, and a cryptographic process.

In one embodiment, an apparatus includes a circuit that implements the above insertion process. The circuit includes a receiver, a tracking message generator, a submessage generator, and an inserter. According to an embodiment, the submessage generator includes a relationship generator and a bit allocator.

In one embodiment, a computer-implemented method of extracts tracking information to track content steganographically. The method includes receiving processed content that includes submessages. The submessages have been steganographically inserted into the processed content. The method further includes extracting the submessages from the processed content. The method further includes relating the submessages together according to relationship information in the submessages. The method further includes generating a tracking message from the submessages having been related together according to the relationship information.

In one embodiment, the method of relating the submessages includes selecting a first subset of more than one of the submessages, assembling the first subset to generate an assembled message, generating a second subset of submessages from the assembled message, and comparing the second subset to the first subset.

In one embodiment, an apparatus includes a circuit that implements the above extraction process. The circuit includes an extractor and a relator. According to an embodiment, the relator includes a selector, an assembler, a submessage generator, and a comparator.

In this manner, the amount of information communicated in the tracking messages may be increased without requiring a redesign of every message insertion device in a distribution chain.

The following detailed description and accompanying drawings provide a better understanding of the nature and advantages of the present invention.

### BRIEF DESCRIPTION OF THE DRAWINGS

FIG. 1 is a block diagram of a message generator system according to an embodiment of the present invention.

FIG. 2 is a flow diagram of a method for generating tracking information according to an embodiment of the present invention.

FIG. 3 is a block diagram showing details of a submessage generator according to an embodiment of the present invention.

FIG. 4 is a block diagram of a message extraction system according to an embodiment of the present invention.

FIG. 5 is a flow diagram of a method of extracting tracking information according to an embodiment of the present invention.

FIG. 6 is a block diagram showing details of a relator according to an embodiment of the present invention.

### DETAILED DESCRIPTION

Described herein are techniques for message generation in forensic watermarking. In the following description, for purposes of explanation, numerous examples and specific details are set forth in order to provide a thorough understanding of the present invention. It will be evident, however, to one skilled in the art that the present invention as defined by the claims may include some or all of the features in these examples alone or in combination with other features described below, and may further include modifications and equivalents of the features and concepts described herein.

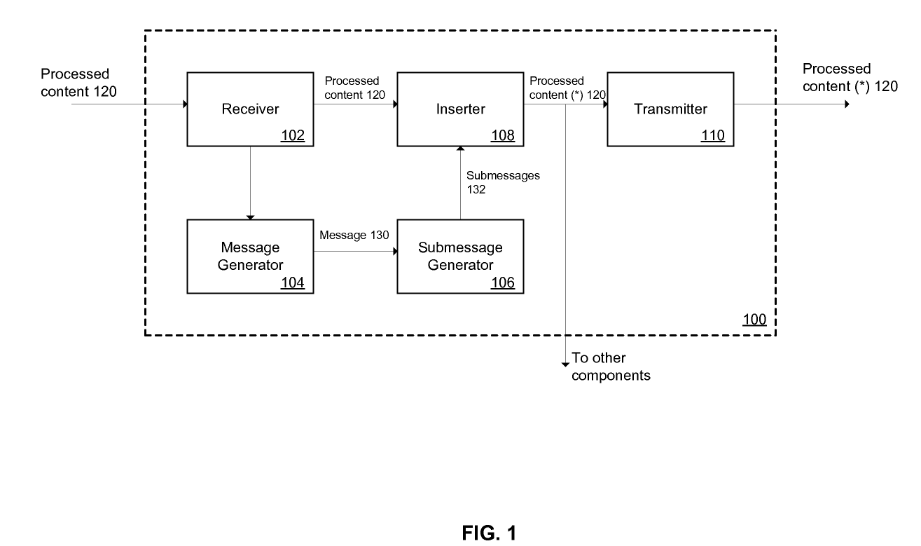

FIG. 1 is a block diagram of a message generator system 100 according to an embodiment of the present invention. The message generator system 100 may be a component of another device, such as a distribution device (e.g., a cable headend, a television transmitter, a satellite transmitter, an internet router, etc.) or a playback device (e.g., a cable box, a television receiver, a set top box STB, a satellite receiver, a computer, a DVD player, a mobile phone, etc.). The message generator system 100 includes a receiver 102, a message generator 104, a submessage generator 106, an inserter 108, and a transmitter 110.

The receiver 102 receives processed content 120. The processed content 120 is content that has been previously processed for the subsequent steganographic insertion of watermarking messages. Such previous processing may have been performed according to one of the examples set forth in U.S. Pat. No. 6,285,774 (which is incorporated herein by reference) or otherwise performed by the devices of Cinea, Inc., Reston, Va. In general, the pre-processing adjusts the content to include “message holes” and metadata that identifies the message holes. The metadata may be directly in the video part of the stream (referred to as the elementary stream), or may be at a higher level of content packaging (for example, packaged in the transport stream, packaged in MP4 format, packaged in Quicktime format, etc.) The metadata may be cleared at the end distribution point (for example, at the STB) when the content is displayed.

According to an embodiment, the receiver 102 signals the message generator 104 that the processed content 120 is being received. The content of this signal may be adjusted as desired according to the type of information that the message generator 104 needs.

The message generator 104, in response to the processed content 120 being received, generates a tracking message 130. The tracking message 130 may include data that identifies the device associated with the message generator system 100 (for example, an identifier for a specific DVD player or a specific STB), data that identifies the content (for example, an identifier for the specific DVD or other content copy being played by the device), and time stamp data (for example, the date and time that the DVD is being played). In a video on demand environment, the message generator 104 in the VOD server may generate the tracking message 130 to include a customer account number that corresponds to the requested content, a transaction identifier for the request, or some other identifier to link the request, the content and the customer. The message generator 104 provides the tracking message 130 to the submessage generator 106.

The submessage generator 106 receives the tracking message 130 and generates two or more submessages 132 from the tracking message 130. The submessages 132 include relationship information that relates the submessages 132 together. For example, when four submessages (corresponding to two messages) are inserted into the processed content, the relationship information indicates which two submessages are related together, as well as the order of the two submessages.

In general, the use of submessages allows the size of the tracking message 130 to be increased without requiring adjustment of the methods for processing the content for insertion of the tracking information, for inserting the tracking information into the processed content, or for extracting the tracking information from the processed content. Further details regarding the submessages 132 and the relationship information are provided in other sections of this disclosure.

The inserter 108 inserts the submessages 132 steganographically into the processed content 120. Such steganographic insertion may be performed according to one of the examples set forth in U.S. Pat. No. 6,285,774 or otherwise performed by the devices of Cinea, Inc., Reston, Va. (In FIG. 1, the processed content 120 with the insertions is denoted with an asterisk.) As such, the inserter 108 transforms the processed content 120 from untrackable content to trackable content. The inserter 108 outputs the processed content 120 to other components of the device incorporating the message insertion system 100 (for example, the display of a DVD player, the bus of a computer, etc.).

The transmitter 110 (optional) transmits the processed content 120 to devices other than the device incorporating the message insertion system 100. For example, if a set top box incorporates the message insertion system 100, the transmitter 110 includes circuit elements to interface the set top box to a cable (for example) to transmit the signal to a television.

According to an embodiment, at least parts of the message generator 104, the submessage generator 106, and the inserter 108 may be implemented as circuit elements. According to an embodiment, at least parts of the message generator 104, the submessage generator 106, and the inserter 108 may be implemented as a computer program that controls specific hardware devices. In general, it is desirable for the inserter 108 to be tightly coupled in-between the decryption and decoding, since this is a window of vulnerability.

According to an embodiment, the message generator 104 generates tracking messages 130 in the absence of the signal from the receiver 102 that content is being received. The submessage generator 106 generates the submessages 132 based on these tracking messages 130. The inserter 108 then inserts the submessages when the processed content 120 is present; when the processed content 120 is absent, the inserter 108 need not do anything with the submessages 132.

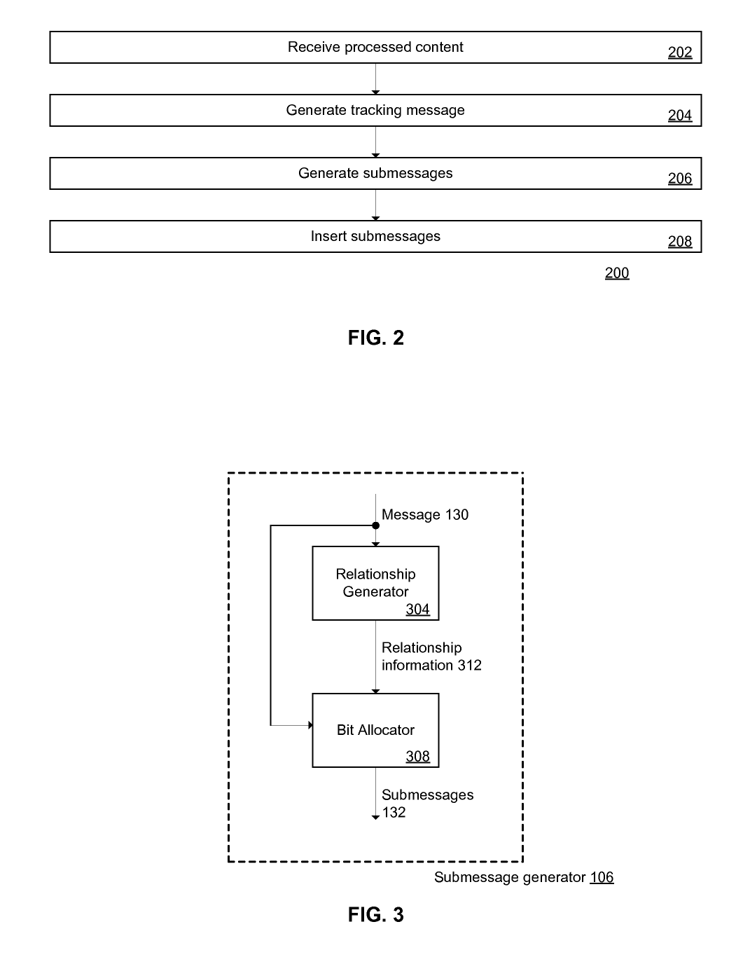

FIG. 2 is a flow diagram of a method 200 for generating tracking information according to an embodiment of the present invention. The method 200 may be performed by a device such as the message insertion system 100.

In step 202, processed content is received at a device. The processed content has been previously processed, as discussed above, for subsequent steganographic insertion of tracking messages.

In step 204, a tracking message is generated that identifies the device. Details regarding the tracking message are provided in other sections of this disclosure.

In step 206, two or more submessages are generated from the tracking message. These submessages include the tracking message as well as relationship information that relates the submessages together. Further details regarding the submessage generation are provided in other sections of this disclosure.

In step 208, the submessages are steganographically inserted into the processed content, and the processed content (that includes the submessages) is outputted.

In this manner, submessages are inserted by each device as content flows through a distribution channel. The content may then be tracked back through the distribution channel, identifying each device in the channel, by extracting the tracking information. By splitting the message into submessages, an embodiment of the present invention enables a larger amount of information to be contained in the message, without requiring a redesign of the entire system to use a larger message format. Multiple submessages may then be used in place of a single larger message.

FIG. 3 is a block diagram showing details of the submessage generator 106 according to an embodiment of the present invention. The submessage generator 106 receives a message 130 and generates the submessages 132 (see FIG. 1). As an example, if the message is 128 bits and the inserter 108 (see FIG. 1) is configured to insert messages of 64 bits, the submessage generator 106 may generate three submessages each of 64 bits. Each submessage contains a part of the message as well as relationship information (discussed below). The submessage generator 106 includes a relationship generator 304 and a bit allocator 308.

The relationship generator 304 receives the message 130 and generates relationship information 312. For example, using the three submessages from the example above, two of the submessages may include 48 bits of the message and one of the submessages may include 32 bits of the message (128 bits total). As the submessages are each 64 bits, this leaves 64 bits for the relationship information. For such an example, the relationship generator 304 may generate a 64 bit checksum.

The relationship generator 304 may implement one or more of a variety of processes to generate the relationship information. According to an embodiment, the relationship generator 304 implements a cyclic redundancy check. According to an embodiment, the relationship generator 304 implements a cryptographic hash. According to an embodiment, the relationship generator 304 implements a cryptographic process. According to an embodiment, the relationship generator implements an elliptical curve process. The particular method performed may be selected based upon the maximum amount of information that it is anticipated will be inserted over the course of distribution. Each method has a limit for such maximum amount of information. For example, an MD-5 hash may be used to relate up to approximately 300 megabytes of information, and uses 16 bytes for the corresponding relationship information. As another example, a CRC-32 or similar process uses 32 bits for the corresponding relationship information, and may be used to relate an amount of messages that are anticipated to be used according to an embodiment of the present invention.

The bit allocator 308 receives the message 130 and the relationship information 312, and generates the submessages 132. For example, using the 128 bit message and 64 bit checksum from above, the bit allocator 308 may allocate the bits to the three submessages as follows: to the first submessage, 48 bits of the message and 16 bits of the relationship information; to the second submessage, 48 bits of the message and 16 bits of the relationship information; and to the third submessage, 32 bits of the message and 32 bits of relationship information.

The bit allocator 308 may allocate each portion of the relationship information 312 to a defined position in each submessage 132, to aid in extraction (discussed in more detail below). (That is, the extractor may operate more efficiently if it knows where to look to find the relationship information.) For example, the tracking system 100 may be configured to generate submessages of 64 bits, with the most significant 16 bits holding that submessage's relationship information, and the least significant 48 bits holding that submessage's portion of the tracking message.

In general, the bit allocator 308 may be configured based on the desired submessage size “x”, the message size “m”, and the size of the relationship information “r” (expressed in bits). If there are two message components of lengths “m1” and “m2”, the formula to determine the number of submessages needed is:

((m1+m2+r)% x)+1)

where the operator “%” indicates the function of integer division.

So for the example above with a 128 bit message using a CRC-32 method to generate the relationship information (32 bits):

((128+32) % 64)+1=3

More generically for a message with “n” message components, the formula is:

((m1+m2+ . . . +mn+r)% x)+1)

The relationship information may be allocated to each of the submessages in a similar manner. To put a roughly equal number of bits in each submessage, just divide the size of the relationship information by the number of submessages. For example, with 3 submessages and r=32, 32/3 divides into 11, 11 and 10 bits.

According to an embodiment, the processed performed by the relationship generator 304 results in information that includes both the tracking message 130 and the relationship information 312. For example, a cryptographic process applied to the tracking message 130 results in cryptographic information that includes both the tracking message 130 and the relationship information 312. In such an embodiment, the relationship generator 304 provides the cryptographic information to the bit allocator 308, and the bit allocator 308 need not receive the message 130.

According to an embodiment, the submessage generator 106 may also generate control information that indicates which one of a defined variety of processes has been used to generate the relationship information. (The control information may be considered part of the relationship information generated by the relationship generator 304.) For example, if the submessage generator 106 can perform two types of processes to generate the relationship information, one bit of each submessage may be used to store the control information.

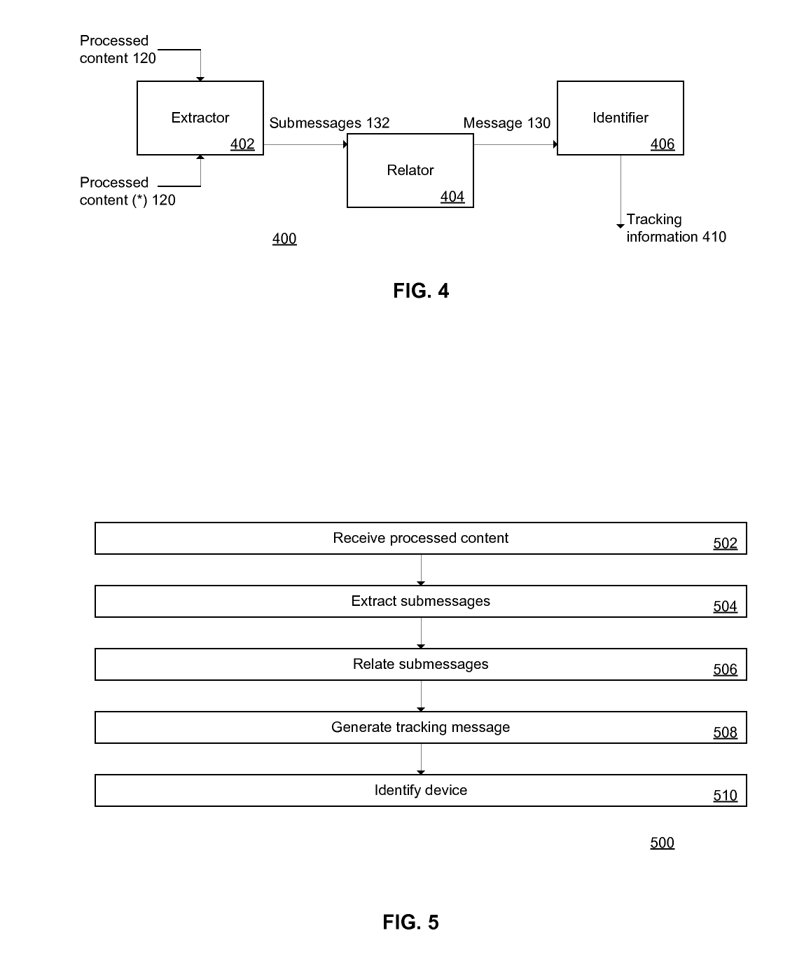

FIG. 4 is a block diagram of a message extraction system 400 according to an embodiment of the present invention. The extraction system 400 is generally used by a content owner (e.g., a copyright owner), or an agent thereof, to track content in order to identify piracy or other unauthorized copying. The extraction system 400 may include one or more of the features according to one of the examples set forth in U.S. Pat. No. 6,285,774 (see, for example, FIGS. 1 and 4B, and accompanying description). The extraction system 400 includes an extractor 402, a relator 404, and an identifier 406.

The extractor 402 receives the processed content 120 in two forms for comparison purposes. One input is the original, processed content 120, which has been processed for the subsequent insertion of tracking information, but for which no tracking information has yet been inserted. The other input is the processed content (*) 120 into which tracking information has been steganographically inserted (for example, by a device that includes the insertion system 100). The extractor compares the processed content 120 (without insertions) and the processed content (*) 120 (with insertions), and as a result of the comparison, extracts the submessages 132 from the processed content (*) 120. The extractor 402 may implement processing according to one of the examples set forth in U.S. Pat. No. 6,285,774.

The relator 404 receives the submessages 132 and outputs one or more tracking messages 130. In general, the relator 404 performs the inverse function of the submessage generator 106 (see FIG. 1). The relator 404 uses the relationship information 312 (see FIG. 3) in two or more submessages 132 to relate those submessages 132 together, and then to generate the tracking message 130 from those related submessages 132. More details of the relator 404 are provided in other sections of this disclosure.

According to an embodiment discussed above, the relationship generator 304 (see FIG. 3) may also generate control information that indicates which specific hash function or encryption process has been used to generate the relationship information. Reciprocally, the relator 404 may then use this control information to select the appropriate hash function or encryption process in order to generate the tracking message 130 in the appropriate manner.

The identifier 406 receives each tracking message 130 from the relator 404 and generates tracking information 410. The tracking information 410 then identifies a device that generated the tracking message 130. Multiple tracking information 410 that identifies a copy of content can then be used to track that content through the various devices. The identifier 406 may implement processing according to one of the examples set forth in U.S. Pat. No. 6,285,774.

According to an embodiment, the identifier 406 need not receive the original, processed content 120, but may recover the tracking information 410 using only the processed content (*) 120. Such recovery is referred to as “blind recovery”. The identifier 406 may implement blind recovery according to one of the example systems of Digimarc Corp., Beaverton, Oreg. In general, blind recovery means that no information from the marking/embedding process is needed to determine how the message was placed in the video.

In a non-blind (informed) recovery system, a log may be kept of where the messages are in the frame. For example, the frame number and the row and column on the frame may be logged so that the mark may be easily located. As another example, the exact movie that was run through the marking process may be used as a baseline for determining changes such as frame rate variances. One disadvantage of informed recovery for broadcast content is that it would be difficult to coordinate all the logs that are created at each head-end.

One way of performing a blind recovery is to subtract adjacent frames from each other. Since there is very little movement between frames at 30 frames per second, subtracting one frame from another results in some minor movement and the added mark. This is a spatial (pixel) domain solution. For encoded video, better results may be achieved by taking into account motion vectors and differences in the discrete cosine domain. It is noteworthy that as the frame rate goes up, adjacent frames become more alike. When a mark is inserted only in one of two adjacent frames, the mark is findable by performing a difference calculation between the two frames and then searching for the marking pattern in the residual or remaining energy.

FIG. 5 is a flow diagram of a method 500 of extracting tracking information according to an embodiment of the present invention. The method 500 may be performed by a device such as the message extraction system 400.

In step 502, processed content that includes two or more submessages is received. The submessages have been previously steganographically inserted into the processed content, for example, by a device that includes the message generator system 100 (see FIG. 1).

In step 504, the submessages are extracted from the processed content by comparing the processed content to the content prior to having been processed. The extraction may be performed by processing according to one of the examples set forth in U.S. Pat. No. 6,285,774.

In step 506, two or more submessages are related together according to relationship information in the submessages. The details of the relationship information and relating submessages together are provided in other sections of this disclosure.

In step 508, a tracking message is generated from the submessages having been related together according to the relationship information. This tracking message corresponds to the tracking message that was generated by a device and inserted into the content (see, for example, FIG. 1 and corresponding description).

In step 510, the tracking message is used to identify a device that outputted the processed content that included the submessages. The identification may be performed by processes according to one of the examples set forth in U.S. Pat. No. 6,285,774.

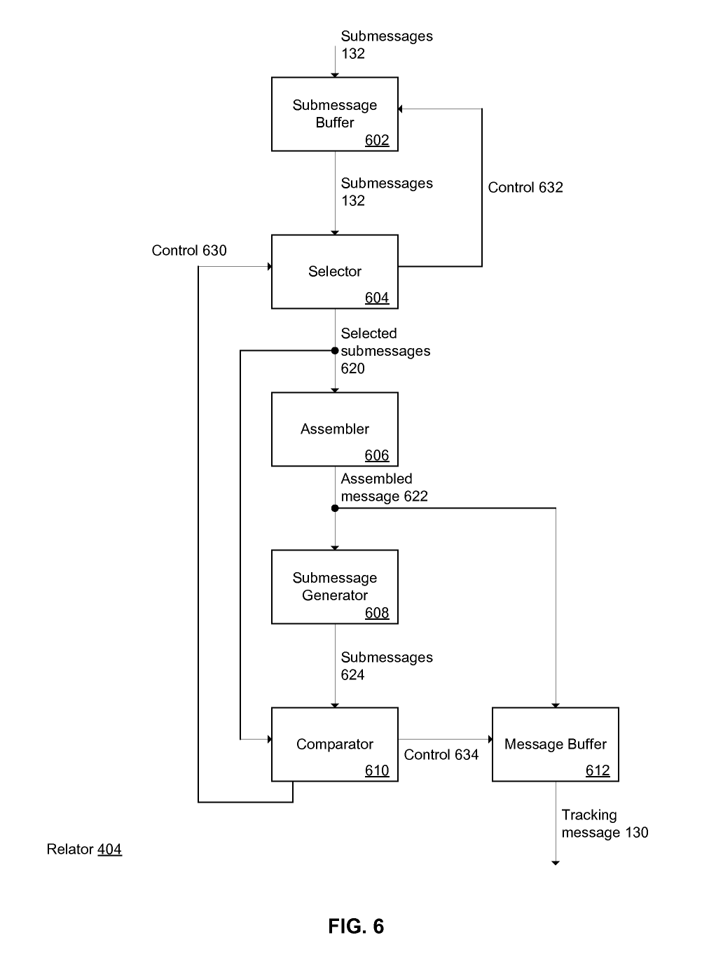

FIG. 6 is a block diagram showing details of the relator 404 according to an embodiment of the present invention. In general, the relator 404 performs an inverse of the functions performed by, for example, the submessage generator 106 (see FIG. 3). The relator 404 includes a submessage buffer 602, a selector 604, an assembler 606, a submessage generator 608, a comparator 610, and a message buffer 612.

The submessage buffer 602 receives the submessages 132 and stores the submessages 132 for selection by the selector 604. The number of submessages stored in the submessage buffer 602 depends upon various factors discussed below.

The selector 604 selects two or more of the submessages stored in the submessage buffer 602 and provides the selected submessages 620 to the assembler 606. The number of submessages selected depends upon the configuration of the tracking system 100 (see FIG. 1) and other factors as discussed below.

The assembler 606 assembles the selected submessages 620 and generates an assembled message 622. In general, the assembler 606 performs an inverse of the function performed by the bit allocator 308 (see FIG. 3).

The submessage generator 608 receives the assembled message 622 and generates submessages 624. In general, the submessage generator 608 performs a similar function as the submessage generator 106 (see FIG. 3).

The comparator 610 receives the selected submessages 622 and the submessages 624. If the selected submessages 622 are related, then the selected submessages 622 match the submessages 624. This is because the assembler 606 and the submessage generator 608 are reconstructing the processes performed by the submessage generator 106 (see FIG. 3). If there is no match, the comparator 610 sends a control signal 630 to the selector 604 to indicate that the selector 604 should select another set of submessages. (Once the selector 604 has selected all the permutations of the submessages in the submessage buffer 602, the selector 604 sends a control signal 632 to the submessage buffer 602 to indicate that it should load the next set of submessages.) In the event of a match, the comparator 610 sends a control signal 634 to the message buffer 612.

The message buffer 612 stores the assembled message 622. In response to the control signal 634 indicating a match, the message buffer 612 outputs the assembled message 622 as the tracking message 130.

Depending upon the design of the tracking system 100, the comparator 610 may perform other functions in the event of a match. For example, if there are more sets of submessages in the submessage buffer 602 that have not yet been related, the comparator 610 may send the control signal 630 to the submessage buffer 602 to indicate that it should load the next set of submessages. If all the submessages in the submessage buffer 602 have been related, the selector 604 may send the control signal 632 to the submessage buffer 602 to indicate that it should load the next set of submessages. According to an embodiment, if the tracking system 100 is designed to insert two submessages sequentially, then the design of the relator 404 may be simplified accordingly.

The specific functions performed by the relationship detector 604 may depend upon the specifics of the tracking system 100 (see FIG. 1). A few example implementations are discussed below.

According to an implementation, the inserter 108 inserts a defined number of submessages sequentially into the processed content 120 (see FIG. 1). In such an implementation, the submessage buffer 602 is sized to hold that number of submessages. Additional submessages (or groups of submessages) enter the submessage buffer 602 in a first-in, first-out operation until the comparator 610 detects a match, at which point the message buffer 612 outputs the tracking message 130 based on those corresponding submessages.

According to an implementation, the inserter 108 inserts related submessages only within a defined portion of the processed content 120 (see FIG. 1). (That is, the processed content includes numerous portions, and related submessages are not placed in more than one portion.) In such an implementation, the submessage buffer 602 is sized to hold the maximum number of submessages that may be inserted within a portion of the processed content 120. The relationship detector 604 selects groups of submessages within the defined portion and analyzes each group to see if the selected submessages are related.

The “defined portion” of the processed content may vary based on the specific format of the content, as well as other design factors of the insertion system. For content in the MPEG-2 format, the defined portion may be a frame (for an entire picture) or a slice (for a subunit of the picture) of the content. For content in the H.264 format, the defined portion may be an access unit (for an entire picture) or a network adaptation layer unit (for a subunit of the picture) of the content. According to embodiments related to U.S. Pat. No. 6,285,774 or otherwise performed by the devices of Cinea, Inc., Reston, Va., related submessages are bounded within a slice or within a network adaptation layer unit.

As another example, consider two submessages “mp2” and “mp1”, where the correct order (that is, the order that results in the correct message being assembled) is “mp2mp1”. The selector 604 selects mp2 and mp1 in both orders for the assembler 606. The comparator 610 then indicates that the assembled message “mp1mp2” is incorrect, and the assembled message “mp2mp1” is correct.

Submessage Formats

There are a variety of submessage formats that may be used depending upon various design factors such as efficiency of splitting, efficiency of recovery, amount of data to be related, etc. For example, the format of the submessages buffers and the recovery may be hard coded. This would be used for a case where it is desired to have, for example, a 128 bit message and that would not change. The system would then “hard code” the division of the message and relationship vector in a defined way.

As another example, the allocation of bits may be variable among the message and relationship vector. In such a case, one solution is to reserve the first four bits of each submessage to define how much of the relationship vector is in that particular submessage. Four bits then indicates that the relationship information occupies between zero and 16 bits (that is, 2̂4 options), and the remainder is the message portion.

Similarly, two bits (for example) may be used to indicate the order in which the submessages are to be assembled. However, this is not a requirement in implementations where the relationship detector 604 performs a more exhaustive comparison of submessages.

As another example, each submessage may receive a discrete portion of the tracking message. For example, if the tracking message contains two discrete pieces of information such as the equipment identifier and the date, the equipment identifier may be placed in one submessage and the date in another submessage. The relationship information then allows the equipment identifier to be matched with the date upon extraction. However, even in the absence of the relationship information (for example, data corruption, etc.), the discrete pieces of information may still be recoverable.

In general, the submessage format is really just a function of the message length and the strength of the relationship. The relationship may be a simple relationship such as a 1 bit even or odd parity. This would involve 1 bit for the relationship part of the message. This provides an indication of a related message, but is not cryptographically strong since even unrelated messages could possibly pass the relationship test.

A CRC function is more appropriate for a shorter message format, but it is still not cryptographically strong. The odds of overlapping results are greatly diminished as the size of the CRC increases (8 bits, 16 bits, 32 bits).

Hashes provide the most cryptographic strength, but can be very long and may cover much more than the maximum combined message lengths.

Thus, the specific choice whether to use a CRC, a hash function, or a more rigorous cryptographic process may be made once the maximum allowed size of the combined submessages has been estimated. This estimation may be performed at the design stage for the system, and then used as a constraint for the design of the message generator system 100.

According to preliminary estimates, submessages of 20 bits using a 16 bit CRC to relate submessages may be appropriate for the informational needs of an embodiment of the present invention. Each submessage may then include 2 control bits “ci”, a portion of bits for the message portion “mp”, and a remaining portion of bits for the relationship portion “rp”. Then, a decision regarding the message length may be made.

The control information may be used to give the length of the rp in each submessage. Assuming that a zero length rp will not occur, the rp may be limited to the counting numbers, which would give lengths of 1, 2, 3, or 4 using 2 bits.

Thus, 5 submessages may be used to represent a 77 bit message:
Sm1|2b ci|15b mp|3b rp|
Sm2|2b ci|15b mp|3b rp|
Sm3|2b ci|15b mp|3b rp|
Sm4|2b ci|15b mp|3b rp|
Sm5|2b ci|17b mp|1b rp|

Similarly, 4 submessages may be used to represent a 56 bit message:
Sm1|2b ci|14b mp|4b rp|
Sm2|2b ci|14b mp|4b rp|
Sm3|2b ci|14b mp|4b rp|
Sm4|2b ci|14b mp|4b rp|

Furthermore, assume that the ci length information represents only even numbers (2, 4, 6, 8). So 3 submessages may be used to represent a 36 bit message:
Sm1|2b ci|12b mp|6b rp|
Sm2|2b ci|12b mp|6b rp|
Sm3|2b ci|12b mp|6b rp|

Or
Sm1|2b ci|10b mp|8b rp|
Sm2|2b ci|10b mp|8b rp|

In the last example, nothing is gained. However, a smaller CRC may be used. For example, a CRC-8 in this case would then change the example to:
Sm1|2b ci|14b mp|4b rp|
Sm2|2b ci|14b mp|4b rp|
   which results in a 28 bit message.

Alternatively, assume the rp is hard coded at 4 bits; in this case, the ci may be omitted. So a 64 bit message may be represented using 4 submessages:
Sm1|16b ci|4b rp|
Sm2|16b ci|4b rp|
Sm3|16b ci|4b rp|
Sm4|16b ci|4b rp|

Similar design choices may be made by varying the size of the message to be represented, the sizes of the submessage, and the type of process used for the relationship information.

Implementation

The invention may be implemented in hardware, executable modules stored on a computer readable medium, or a combination of both (e.g., programmable logic arrays). Unless otherwise specified, the steps included as part of the invention are not inherently related to any particular computer or other apparatus. In particular, various general-purpose machines may be used with programs written in accordance with the teachings herein, or it may be more convenient to construct more specialized apparatus (e.g., integrated circuits) to perform the required method steps. Thus, the invention may be implemented in one or more computer programs executing on one or more programmable computer systems each comprising at least one processor, at least one data storage system (including volatile and non-volatile memory and/or storage elements), at least one input device or port, and at least one output device or port. Program code is applied to input data to perform the functions described herein and generate output information. The output information is applied to one or more output devices, in known fashion.

Each such program may be implemented in any desired computer language (including machine, assembly, or high level procedural, logical, or object oriented programming languages) to communicate with a computer system. In any case, the language may be a compiled or interpreted language.

Each such computer program is preferably stored on or downloaded to a storage media or device (e.g., solid state memory or media, or magnetic or optical media) readable by a general or special purpose programmable computer, for configuring and operating the computer when the storage media or device is read by the computer system to perform the procedures described herein. The inventive system may also be considered to be implemented as a computer-readable storage medium, configured with a computer program, where the storage medium so configured causes a computer system to operate in a specific and predefined manner to perform the functions described herein. (Software per se and intangible signals are excluded to the extent that they are unpatentable subject matter.)

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents will be evident to those skilled in the art and may be employed without departing from the spirit and scope of the invention as defined by the claims.

What is claimed is:

1. A computer-implemented method of generating tracking information to track content steganographically, comprising:
receiving processed content at a device, wherein the processed content has been previously processed for subsequent steganographic insertion of a plurality of tracking messages;
generating a tracking message that identifies the device;
generating a plurality of submessages from the tracking message, wherein the plurality of submessages includes the tracking message, and wherein the plurality of submessages includes relationship information that relates the plurality of submessages together;
inserting the plurality of submessages steganographically into the processed content; and
outputting the processed content that includes the plurality of submessages.

2. The computer-implemented method of claim 1, wherein generating the plurality of submessages comprises:
generating the relationship information from the tracking message;
allocating, to a first submessage, a first portion of the relationship information and a first portion of the tracking message; and
allocating, to a second submessage, a second portion of the relationship information and a second portion of the tracking message.

3. The computer-implemented method of claim 2, wherein generating the relationship information comprises:
applying a cyclic redundancy check to the tracking message.

4. The computer-implemented method of claim 2, wherein generating the relationship information comprises:
applying a cryptographic hash to the tracking message.

5. The computer-implemented method of claim 2, wherein generating the relationship information comprises:
applying a cryptographic process to the tracking message.

6. An apparatus including a circuit for generating tracking information to track content steganographically, comprising:
a receiver that receives processed content, wherein the processed content has been previously processed for subsequent steganographic insertion of a plurality of tracking messages;
a tracking message generator that generates a tracking message that identifies a device;
a submessage generator that generates a plurality of submessages from the tracking message, wherein the plurality of submessages includes the tracking message, and wherein the plurality of submessages includes relationship information that relates the plurality of submessages together; and
an inserter that inserts the plurality of submessages steganographically into the processed content, and that outputs the processed content that includes the plurality of submessages.

7. The apparatus of claim 6, wherein the submessage generator comprises:
a relationship generator that generates the relationship information from the tracking message;
a bit allocator that allocates, to a first submessage, a first portion of the relationship information and a first portion of the tracking message, and that allocates, to a second submessage, a second portion of the relationship information and a second portion of the tracking message.

8. A computer-implemented method of extracting tracking information to track content steganographically, comprising:
receiving processed content that includes a plurality of submessages, wherein the plurality of submessages have been steganographically inserted into the processed content;
extracting the plurality of submessages from the processed content;
relating the plurality of submessages together according to relationship information in the plurality of submessages; and
generating a tracking message from the plurality of submessages having been related together according to the relationship information.

9. The computer-implemented method of claim 8, wherein extracting the plurality of submessages comprises:
extracting the plurality of submessages from the processed content by comparing the processed content to the content prior to having been processed.

10. The computer-implemented method of claim 8, further comprising:
using the tracking message to identify a device that outputted the processed content.

11. The computer-implemented method of claim 8, wherein relating the plurality of submessages together comprises:
selecting a subset of more than one of the plurality of submessages;
assembling the subset to generate an assembled message;
generating a second plurality of submessages from the assembled message; and
comparing the second plurality of submessages to the subset.

12. The computer-implemented method of claim 8, wherein relating the plurality of submessages together comprises:
selecting a first submessage and a second submessage of the plurality of submessages;
assembling the first submessage and the second submessage to generate an assembled message;
applying a cyclic redundancy check to the assembled message to generate the relationship information;
generating a second plurality of submessages from the assembled message and the relationship information; and
comparing the second plurality of submessages to the first submessage and the second submessage.

13. The computer-implemented method of claim 8, wherein relating the plurality of submessages together comprises:
selecting a first submessage and a second submessage of the plurality of submessages;
assembling the first submessage and the second submessage to generate an assembled message;
applying a cryptographic hash to the assembled message to generate the relationship information;
generating a second plurality of submessages from the assembled message and the relationship information; and
comparing the second plurality of submessages to the first submessage and the second submessage.

14. The computer-implemented method of claim 8, wherein relating the plurality of submessages together comprises:
selecting a first submessage and a second submessage of the plurality of submessages;
assembling the first submessage and the second submessage to generate an assembled message;
applying a cryptographic process to the assembled message to generate cryptographic information, wherein the cryptographic information includes the assembled message and the relationship information;
generating a second plurality of submessages from the cryptographic information; and
comparing the second plurality of submessages to the first submessage and the second submessage.

15. An apparatus including a circuit for extracting tracking information to track content steganographically, comprising:
an extractor that receives processed content that includes a plurality of submessages, wherein the plurality of submessages have been steganographically inserted into the processed content, and that extracts the plurality of submessages from the processed content; and
a relator that relates the plurality of submessages together according to relationship information in the plurality of submessages, and that generates a tracking message from the plurality of submessages having been related together according to the relationship information.

16. The apparatus of claim 14, wherein the relator comprises:
a selector that selects a subset of more than one of the plurality of submessages;
an assembler that assembles the subset to generate an assembled message;
a submessage generator that generates a second plurality of submessages from the assembled message; and
a comparator that compares the second plurality of submessages to the subset.
